(19) United States
(12) Patent Application Publication
(10) Pub. No.: US 2008/0017250 A1
(43) Pub. Date: Jan. 24, 2008

(54) Wastewater diverting system

(76) Inventor: Bradley Butler, Grays Point (AU)

Correspondence Address: GLOBAL PATENTS, Suite 120, 838 W. Long Lake Road, Bloomfield Hills, MI, 48302, US

(21) Appl. No.: 11/801,736

(22) Filed: May 11, 2007

(30) Foreign Application Priority Data
Jul. 24, 2006 (AU) PCT/AU06/01032

(51) Int. Cl. F16L 43/00; E03B 3/00

(52) U.S. Cl. 137/247.13; 137/887

(57) ABSTRACT

A wastewater treatment system is disclosed. An illustrative embodiment of the wastewater treatment system includes a drain surface having a drain opening; a main drain conduit disposed in fluid communication with the drain opening; a first diversion conduit and a second diversion conduit disposed in fluid communication with the main drain conduit; and a rotatable diverting device having a diverter opening provided in the main drain conduit. The diverter opening is adapted for fluid communication with a selected one of the first diversion conduit and the second diversion conduit responsive to rotation of the diverting device in the main drain conduit.

### FIELD

The present invention relates to wastewater distribution systems. More particularly, the present invention relates to a wastewater diverting system which is capable of diverting wastewater to a selected one of multiple destinations.

### BACKGROUND

Conventional plumbing drains for sinks, bathtubs, showers and the like include a drain conduit which drains the wastewater to a sewage system. Some of the wastewater (also known as “grey water”) is relatively clean and capable of further use in garden or toilet flushing applications, for example. Therefore, wastewater diverting systems are known which can be used to selectively divert wastewater from a plumbing drain to either a sewage system or a grey water collection system. However, conventional wastewater diverting systems are typically fitted along the pipeline, requiring access of the pipeline to activate the diversion.

### SUMMARY

The present invention is generally directed to a wastewater treatment system. An illustrative embodiment of the wastewater treatment system includes a drain surface having a drain opening; a main drain conduit disposed in fluid communication with the drain opening; a first diversion conduit and a second diversion conduit disposed in fluid communication with the main drain conduit; and a rotatable diverting device having a diverter opening provided in the main drain conduit. The diverter opening is adapted for fluid communication with a selected one of the first diversion conduit and the second diversion conduit responsive to rotation of the diverting device in the main drain conduit.

### BRIEF DESCRIPTION OF THE DRAWINGS

The invention will now be described, by way of example, with reference to the accompanying drawings, in which:

FIG. 1 is a sectional view of a first illustrative embodiment of the wastewater diverting system;

FIG. 2 is a sectional view of a second illustrative embodiment of the wastewater diverting system;

FIG. 3 is a sectional view of a third illustrative embodiment of the wastewater diverting system;

FIG. 4 is a sectional view, taken along section lines 4-4 in FIG. 1; and

FIG. 5 is a sectional view, taken along section lines 5-5 in FIG. 2.

### DETAILED DESCRIPTION

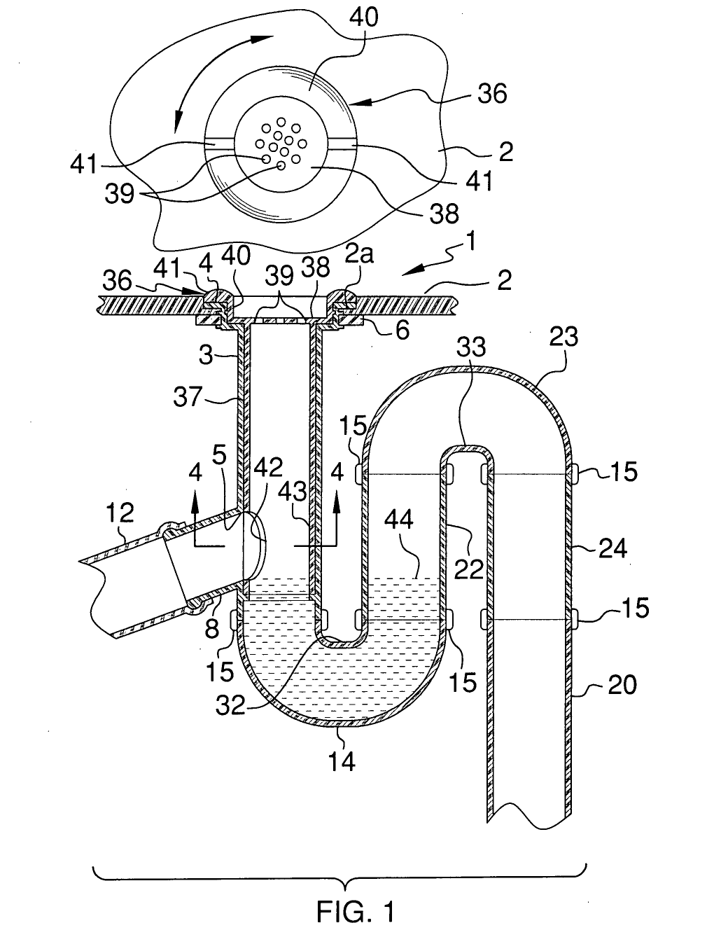

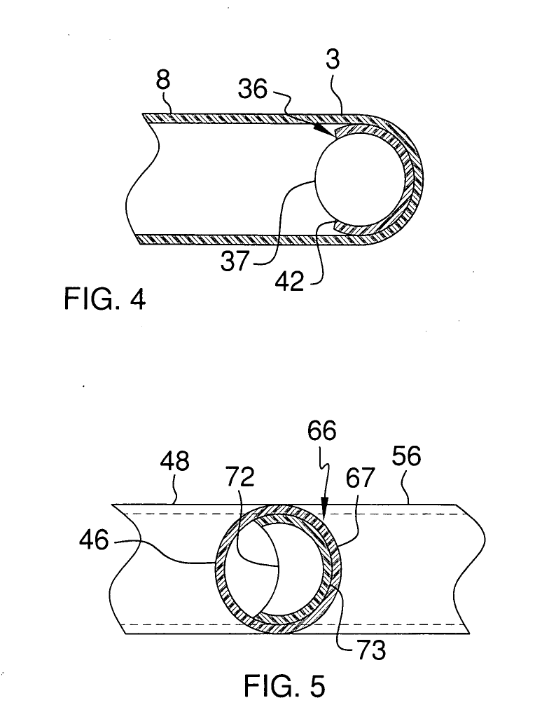

Referring initially to FIGS. 1 and 4 of the drawings, an illustrative embodiment of the wastewater diverting system, hereinafter system, is generally indicated by reference numeral 1. The system 1 includes a drain surface 2 which may be any surface that receives wastewater such as a bottom of a bathtub or sink (not shown) or a floor of a shower (not shown), for example. A drain opening 2a extends through the drain surface 2. A main drain conduit 3 is disposed in fluid communication with the drain opening 2a. The main drain conduit 3 typically includes a main drain conduit flange 4 which is seated in the drain opening 2a. An o-ring 6 typically seals the interface between the main drain flange 4 and the drain opening 2a. A diverter conduit opening 5 is provided in the main drain conduit 3, in spaced-apart relationship with respect to the main drain conduit flange 4. A gray water diverter conduit nipple 8 is disposed in fluid communication with the diverter conduit opening 5 and angles downwardly from the main drain conduit 3. A gray water diversion conduit 12 is disposed in fluid communication with the gray water diversion conduit 8.

An “S” trap connects the sewer conduit 20 in fluid communication with the main drain conduit 3. The “S” trap includes a curved trap conduit 14 which is connected to the outlet of the main drain conduit 3. An axial proximal connecting conduit 22 is connected to the outlet of the trap conduit 14. A curved return conduit 23 is connected to the outlet of the proximal connecting conduit 22. A distal connecting conduit 24 connects the outlet of the return conduit 23 to the inlet of the sewer conduit 20. Conduit clamps 15 typically connect the conduits to each other. Accordingly, a low water mark 32 is located between the main drain conduit 3 and the proximal connecting conduit 22, whereas a high water mark 33 is located between the proximal connecting conduit 22 and the distal connecting conduit 24. The sewer conduit 20 is connected to a sewage system (not shown), whereas the grey water diversion conduit 12 is connected to a system for re-using wastewater in any of a variety of applications.

A diverting device 36 is mounted for rotation in the main drain conduit 3. The diverting device 36 includes a diverting conduit 37 having a generally elongated, cylindrical shape. A diverting plate 38, having multiple drain perforations 39, closes one end of the diverting conduit 37. A typically circular or annular plate flange 40 extends from the diverting plate 38. At least one tab 41 is provided on the plate flange 40. As shown in the top portion of FIG. 1, a pair of spaced-apart tabs 41 is typically provided on the plate flange 40. A diverter opening 42 extends through the diverting conduit 37 in spaced-apart relationship with respect to the diverting plate 38. A blocking portion 43 extends from the diverting conduit 37, opposite or in diametrically-opposed relationship with respect to the diverter opening 42. Accordingly, the diverting device 36 can be selectively rotated in the main drain conduit 3 by gripping the tabs 41 and rotating the plate flange 40 and diverting plate 38, and therefore, the diverting conduit 37 in the main drain conduit 3.

In typical use, wastewater 44 is drained from the drain surface 2, through the drain perforations 39 and into the diverting conduit 37, respectively. Prior to drainage of the wastewater 44, the diverting device 36 is rotated in the main device conduit 3 to position the diverter opening 42 in fluid communication with the diverter conduit opening 5, gray water diverter conduit nipple 8 and gray water diversion conduit 12, as shown in FIGS. 1 and 4, to divert at least a portion of the wastewater 44 to the gray water diversion conduit 12 for continued use of the wastewater 44 in any of a variety of applications such as garden or toilet flushing applications, for example. Some of the wastewater 44 is diverted through the “S” trap to the sewer conduit 20 and is discharged to a sewer system (not shown). Alternatively, the diverting device 36 can be selectively positioned such that the blocking portion 43 of the diverting device 36 closes or blocks the diverter conduit opening 5 and flow of the wastewater 44 to the gray water diversion conduit 12. In that case, all of the wastewater 44 which is drained through the drain perforations 39 is diverted to the sewer conduit 20.

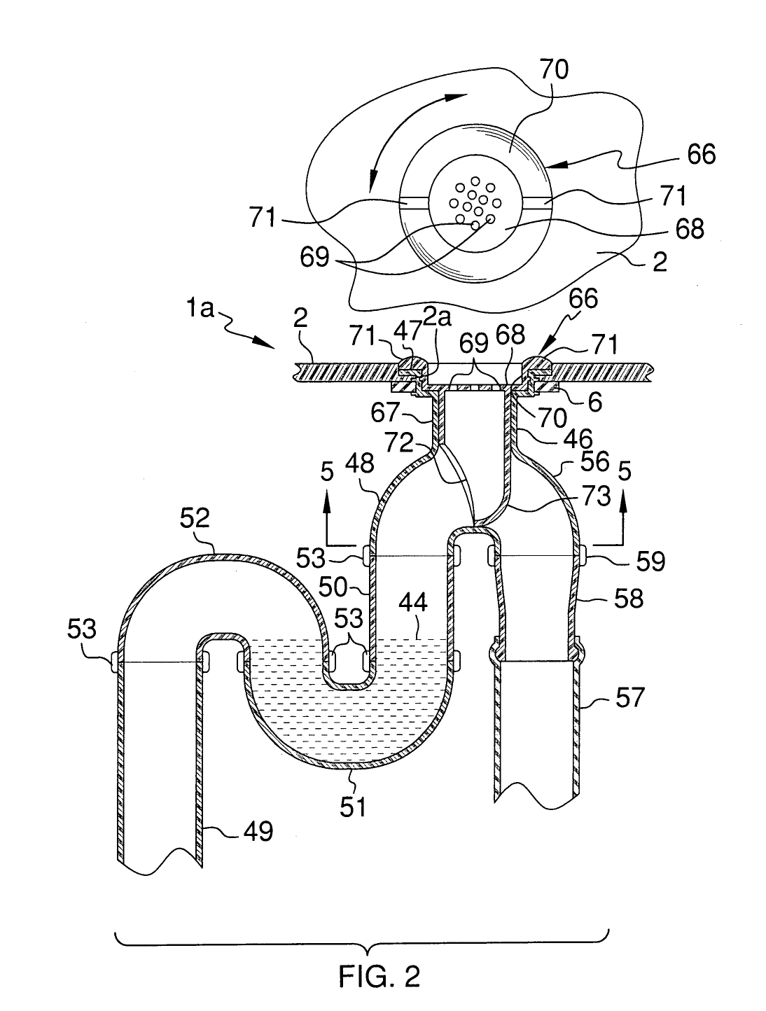

Referring next to FIGS. 2 and 5 of the drawings, an alternative illustrative embodiment of the fluid diverting system, hereinafter system, is generally indicated by reference numeral 1a. The system 1a includes a main drain conduit 46 having a main drain conduit flange 47 which is seated in the drain opening 2a in the drain surface 2. A sewer diversion conduit 48 and a gray water diversion conduit 56 diverge from the main drain conduit 46. An “S” trap connects the sewer diversion conduit 48 to a sewer conduit 49. The “S” trap includes an axial proximal connecting conduit 50 which is connected to the outlet of the sewer diversion conduit 48, a curved trap conduit 51 which is connected to the outlet of the proximal connecting conduit 50 and a curved return conduit 52 which connects the outlet of the trap conduit 51 to the inlet of the sewer conduit 49. Conduit clamps 53 typically connect the conduits to each other.

A connecting conduit 58 connects the outlet of the gray water diversion conduit 56 to the inlet of a gray water conduit 57. A conduit clamp 59 typically connects the connecting conduit 58 to the gray water diversion conduit 56. The sewer conduit 49 is connected to a sewage system (not shown), whereas the grey water conduit 57 is connected to a system for re-using wastewater in any of a variety of applications.

A diverting device 66 is mounted for rotation in the main drain conduit 46. The diverting device 66 includes a diverting conduit 67 having a generally elongated, cylindrical shape. A diverting plate 68, having multiple drain perforations 69, closes one end of the diverting conduit 67. A typically circular or annular plate flange 70 extends from the diverting plate 68. At least one tab 71 is provided on the plate flange 70. As shown in the top portion of FIG. 2, a pair of spaced-apart tabs 71 is typically provided on the plate flange 70. A diverter opening 72 extends through the diverting conduit 67 in spaced-apart relationship with respect to the diverting plate 68. A generally curved blocking portion 73 extends from the diverting conduit 67, opposite or in diametrically-opposed relationship with respect to the diverter opening 72. Accordingly, the diverting device 66 can be selectively rotated in the main drain conduit 46 by gripping the tabs 71 and rotating the plate flange 70 and diverting plate 68, and therefore, the diverting conduit 67 in the main drain conduit 46.

In typical use, the diverting device 66 is rotated in the main drain conduit 46 to selectively align the diverter opening 72 with the sewer diversion conduit 48, as shown in FIGS. 2 and 5, or the gray water diversion conduit 56. When the diverter opening 72 is aligned with the sewer diversion conduit 48, as shown, wastewater 44 flows to the sewer diversion conduit 49, which distributes the wastewater 44 to the sewage system (not shown). Simultaneously, the blocking portion 73 blocks communication between the diverting conduit 67 and the gray water conduit 57. When the diverter opening 72 is aligned with the gray water diversion conduit 56, wastewater 44 flows to the gray water conduit 57, which distributes the wastewater 44 for continued use of the wastewater 44 in any of a variety of applications. The blocking portion 73 prevents flow of wastewater 44 to the sewer conduit 49.

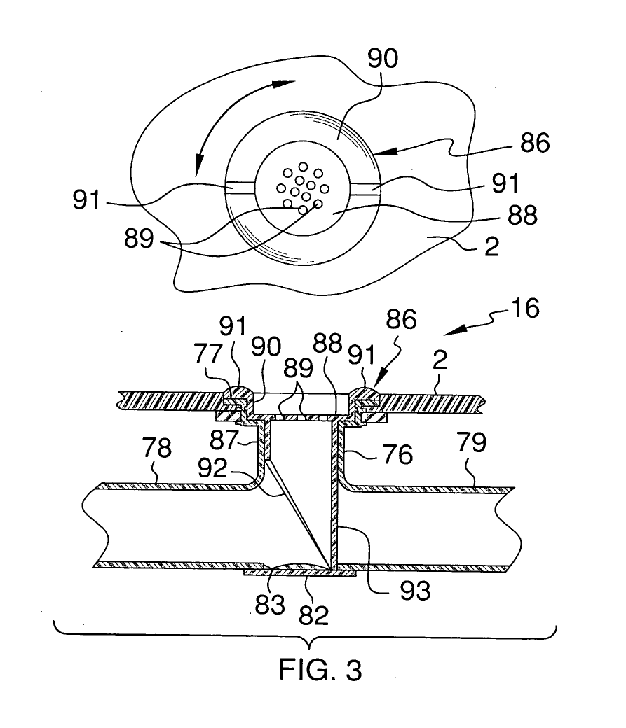

Referring next to FIG. 3 of the drawings, still another illustrative embodiment of the fluid diverting system, hereinafter system, is generally indicated by reference numeral 1b. The system 1b includes a main drain conduit 76 having a main drain conduit flange 77 which is seated in the drain opening 2a in the drain surface 2. A sewer diversion conduit 78 and a gray water diversion conduit 79 diverge from the main drain conduit 46 and are disposed substantially in axially-aligned relationship with respect to each other. A conduit connecting plate 82 is provided between the sewer diversion conduit 78 and the gray water diversion conduit 79. A circular conduit seat 83 is defined between the sewer diversion conduit 78, the gray water diversion conduit 79 and the conduit connecting plate 82.

A diverting device 86 is mounted for rotation in the main drain conduit 76. The diverting device 86 includes a diverting conduit 87 having a generally elongated, cylindrical shape. A diverting plate 88, having multiple drain perforations 89, closes one end of the diverting conduit 87. A typically circular or annular plate flange 90 extends from the diverting plate 88. At least one tab 91 is provided on the plate flange 90. As shown in the top portion of FIG. 3, a pair of spaced-apart tabs 91 is typically provided on the plate flange 90. A diverter opening 92 extends through the diverting conduit 87 in spaced-apart relationship with respect to the diverting plate 88. A generally straight blocking portion 93 extends from the diverting conduit 87, opposite or in diametrically-opposed relationship with respect to the diverter opening 92. The blocking portion 93 is seated in the conduit seat 83. Accordingly, the diverting device 86 can be selectively rotated in the main drain conduit 76 by gripping the tabs 91 and rotating the plate flange 90 and diverting plate 88, and therefore, the diverting conduit 87 in the main drain conduit 76.

In typical use, the diverting device 86 is rotated in the main drain conduit 76 to selectively align the diverter opening 92 with either the sewer diversion conduit 78, as shown in FIG. 3, or the gray water diversion conduit 79. When the diverter opening 92 is aligned with the sewer diversion conduit 78, as shown, wastewater (not shown) flows to the sewer diversion conduit 78, which distributes the wastewater to the sewage system (not shown). Simultaneously, the blocking portion 93 blocks communication between the diverting conduit 87 and the gray water diversion conduit 79. When the diverter opening 92 is aligned with the gray water diversion conduit 79, wastewater flows into the gray water diversion conduit 79, which distributes the wastewater for continued use of the wastewater in any of a variety of applications. The blocking portion 93 prevents flow of wastewater into the sewer diversion conduit 78.

While the preferred embodiments of the invention have been described above, it will be recognized and understood that various modifications can be made in the invention and the appended claims are intended to cover all such modifications which may fall within the spirit and scope of the invention.

What is claimed is:

1. A wastewater treatment system, comprising:
a drain surface having a drain opening;
a main drain conduit disposed in fluid communication with said drain opening;
a first diversion conduit and a second diversion conduit disposed in fluid communication with said main drain conduit;
a rotatable diverting device having a diverter opening provided in said main drain conduit; and
wherein said diverter opening is adapted for fluid communication with a selected one of said first diversion conduit and said second diversion conduit responsive to rotation of said diverting device in said main drain conduit.

2. The system of claim 1 wherein said first diversion conduit comprises a gray water diversion conduit and said second diversion conduit comprises an “S” trap and further comprising a sewer conduit disposed in fluid communication with said “S” trap.

3. The system of claim 1 further comprising a sewer conduit disposed in fluid communication with said first diversion conduit and a gray water conduit disposed in fluid communication with said second diversion conduit.

4. The system of claim 1 wherein said diverting device comprises a diverting conduit extending into said main drain conduit and said diverter opening is provided in said diverting conduit.

5. The system of claim 4 further comprising a blocking portion extending from said diverting conduit in spaced-apart relationship with respect to said diverter opening.

6. The system of claim 5 wherein said blocking portion is generally straight.

7. The system of claim 5 wherein said blocking portion is generally curved.

8. The system of claim 4 further comprising a diverting plate having a plurality of drain perforations provided on said diverting conduit and disposed in said drain opening.

9. A wastewater treatment system, comprising:
a drain surface having a drain opening;
a main drain conduit disposed in fluid communication with said drain opening;
a first diversion conduit and a second diversion conduit disposed in fluid communication with said main drain conduit;
a rotatable diverting device having a diverting conduit provided in said main drain conduit, a diverter opening provided in said diverting conduit, a diverting plate having a plurality of drain perforations provided on said diverting conduit, a plate flange extending from said diverting plate and rotatably mounted in said drain opening and at least one tab extending from said plate flange; and
wherein said diverter opening is adapted for fluid communication with a selected one of said first diversion conduit and said second diversion conduit responsive to rotation of said diverting device in said main drain conduit.

10. The system of claim 9 further comprising a blocking portion extending from said diverting conduit in spaced-apart relationship with respect to said diverter opening.

11. The system of claim 10 wherein said blocking portion is generally straight.

12. The system of claim 10 wherein said blocking portion is generally curved.
